(19) United States
(12) Patent Application Publication
(10) Pub. No.: US 2009/0044412 A1
(43) Pub. Date: Feb. 19, 2009

(54) Garden shears

(76) Inventor: Jung-Te Hsieh, Lugang Chen (TW)

Correspondence Address: Hershkovitz & Associates, LLC, 2845 Duke Street, Alexandria, VA, 22314, US

(21) Appl. No.: 11/889,508

(22) Filed: Aug. 14, 2007

(51) Int. Cl. B26B 13/00; B26B 13/06

(52) U.S. Cl. 30/252; 30/356

(57) ABSTRACT

A pair of garden shears has a first handle, a second handle, a first blade and a second blade. The second handle has a first slot defined through the second handle. The first blade is pivotally connected to the first handle with a first pivot, is pivotally connected to the second handle with a second pivot and has a curved second slot corresponding to the first slot. The second blade is pivotally connected to the first blade with a third pivot, is pivotally connected to the first handle with a fourth pivot, is pivotally connected to the second handle and the first blade with a fifth pivot and has a third slot. The fourth pivot extends through the first handle and slidably through the third slot. The fifth pivot slidably extends through the first slot and the curved second slot.

### BACKGROUND OF THE INVENTION

1. Field of the Invention

The present invention relates to a pair of garden shears, and more particularly to a pair of garden shears that is easily and convenient in use and has a capability of minimizing the force for using the shears.

2. Description of Related Art

With reference to FIGS. 7 and 8, a conventional garden shears in accordance with the prior art comprises a first handle (70) provided with a first blade (74), a second handle (72) and a second blade (76). The first blade (74) is integrally formed on one end of the first handle (70). The second blade (76) is pivotally connected to the first blade (74) with a first pivot (80) and pivotally connected to the second handle (72) and has a curved first slot (762) and a straight second slot (764). A second pivot (82) extends through the second handle (72) and slidably through the curved first slot (762) to pivotally connect the second blade (76) to the second handle (72) at a first slidable pivoting point. A third pivot (84) extends through the second handle (72) and slidably through the straight second slot (764) to pivotally connect the second blade (76) to the second handle (72) at a second slidable pivoting point.

In use, the handles are held by a user with two hands and are squeezed to close to each other, and the second blade (76) will be pivoted relative to the second handle (72) and the first blade (74) so that the blades (74,76) are closed to cut or prune trees, flowers or grasses.

However, when the conventional shears is in use, only the second blade (76) is pivoted relative to the second handle (72) and the first blade (74) integrally formed on the first handle (70) is always kept stationary. Consequently, to cut or prune a tree, flower or grass, the second handle (72) with the second blade (76) pivotally connecting thereto is the mainly moving element of the conventional shears, and a right hand user or a left hand user always holds and activates the second handle (72) with his or her right/left hand. Therefore, the conventional shears always has to be turned over for fitting with different users, so the use of the conventional shears is inconvenient.

Additionally, because only the second blade (76) pivots relative to the second handle (72) during the cutting process, the magnifying effect to force from handles (70,72) to blades (74,76) of the conventional shears is not enough for cutting or pruning a branch of a tree with a large diameter. A large force is always needed for cutting a large tree branch or even impossible for that.

To overcome the shortcomings, the present invention tends to provide a garden shears to mitigate or obviate the aforementioned problems.

### SUMMARY OF THE INVENTION

The main objective of the invention is to provide a pair of garden shears that is easily and convenient in use and has a capability of minimizing the force for using the shears. The pair of garden shears has a first handle, a second handle, a first blade and a second blade. The first handle has a pivotal end. The second handle has a pivotal end and a first slot defined through the pivotal end of the second handle. The first blade is pivotally connected to the pivotal end of the first handle with a first pivot, is pivotally connected to the second handle with a second pivot and has a cutting end, a pivotal end and a curved second slot. The pivotal end is pivotally connected to the second handle with the second pivot. The curved second slot corresponds to the first slot. The second blade is pivotally connected to the first blade with a third pivot, is pivotally connected to the first handle with a fourth pivot, is pivotally connected to the pivotal end of the second handle and the first blade with a fifth pivot and has a cutting end, a pivotal end and a third slot. The cutting end corresponds to the cutting end of the first blade. The fourth pivot extends through the first handle and slidably through the third slot to pivotally connect the second blade to the first handle. The fifth pivot slidably extends through the first slot and the curved second slot to pivotally connect the second blade to the second handle and the first blade.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a pair of garden shears in accordance with the present invention;

FIG. 2 is an exploded perspective view of the garden shears in FIG. 1;

FIG. 3 is an enlarged operational side view of the garden shears showing the blades being opened;

FIG. 4 is an enlarged operational side view of the garden shears showing the movement of the blades during a cutting process;

FIG. 5 is an enlarged operational side view of the garden shears showing the blades being closed;

FIG. 6 is an enlarged side view of a second embodiment of a pair of garden shears in accordance with the present invention;

FIG. 7 is a side view of a conventional garden shears in accordance with the prior art; and

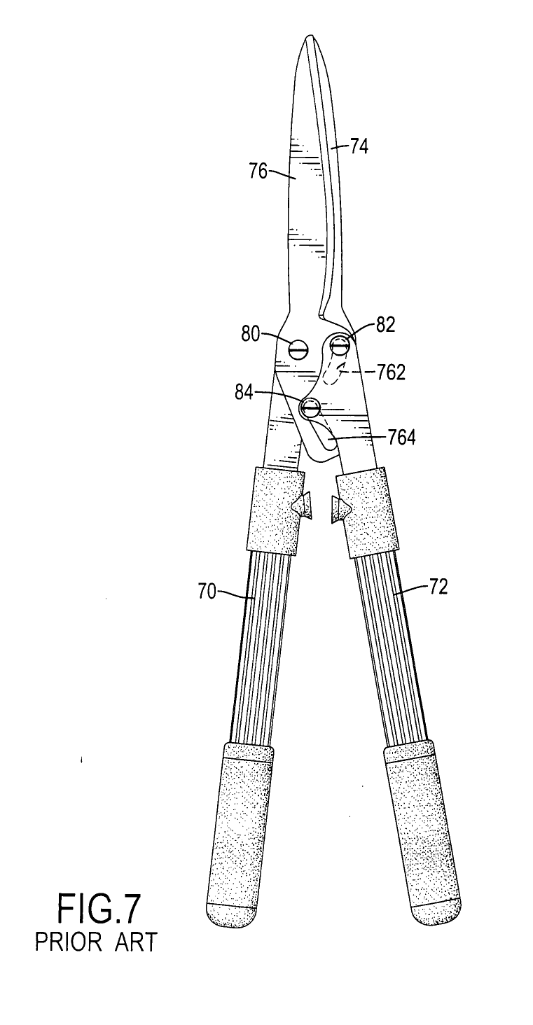

FIG. 8 is an exploded perspective view of the garden shears in FIG. 7.

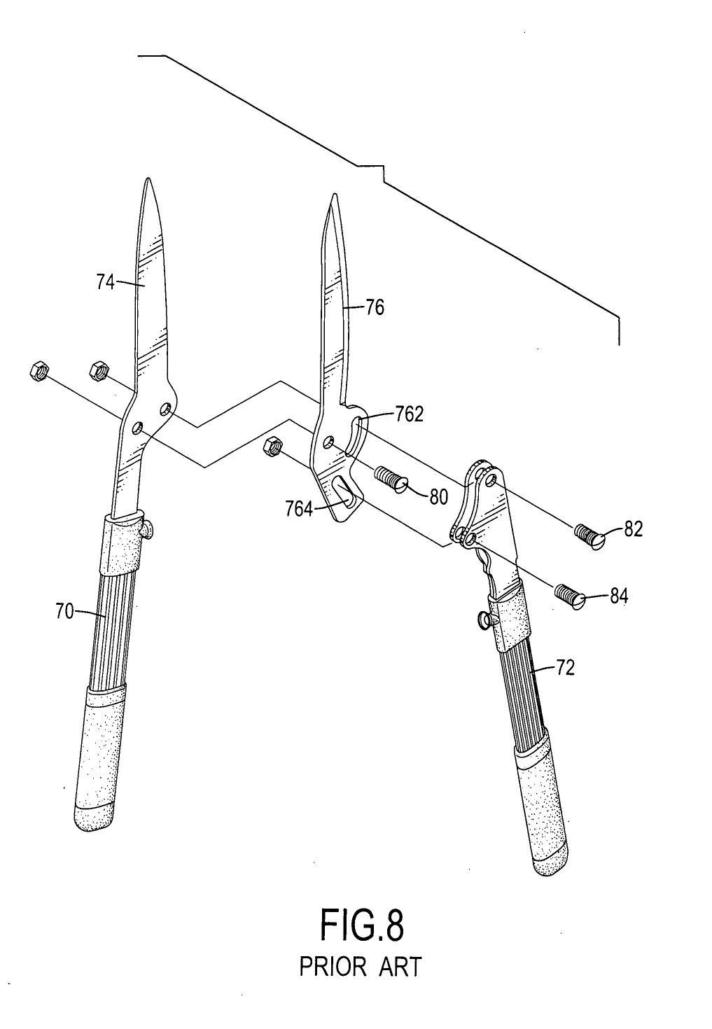

### DETAILED DESCRIPTION OF PREFERRED EMBODIMENT

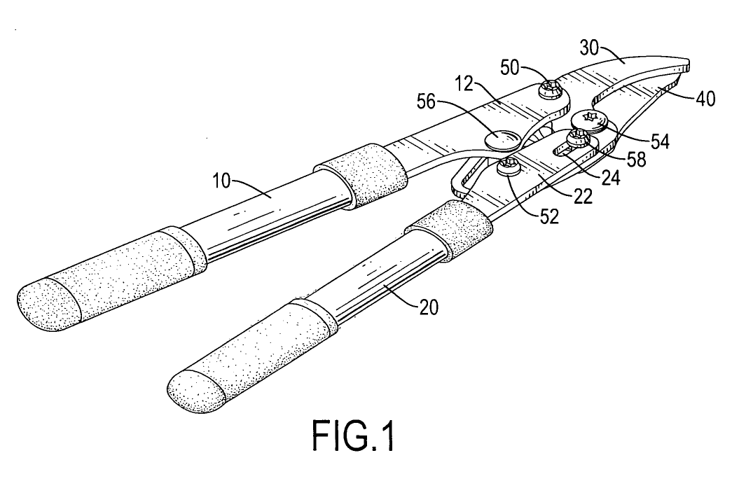

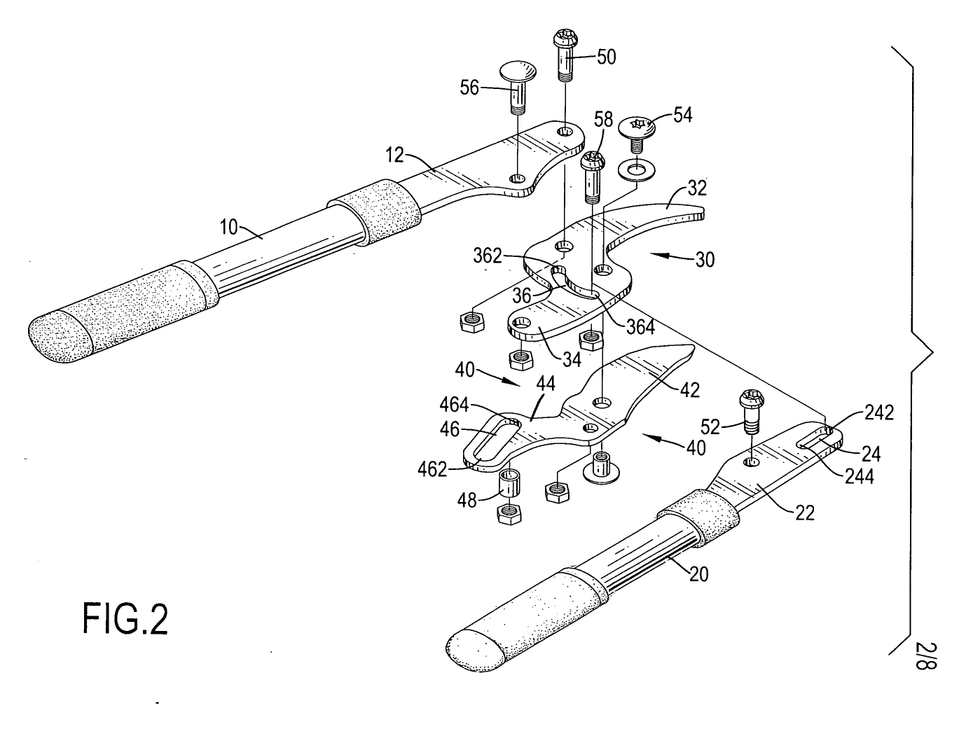

With reference to FIGS. 1 and 2, a pair of garden shears in accordance with the present invention comprises a first handle (10), a second handle (20), a first blade (30) and a second blade (40). The first handle (10) is elongated and has a pivotal end (12) and a handle end opposite to the pivotal end (12). The second handle (20) is elongated and has a pivotal end (22), a handle end opposite to the pivotal end and a first slot (24), defined through the pivotal end (22). The first slot (24) is preferably straight and has a first end (242) away from the handle end of the second handle (20) and a second end (244) facing the handle end.

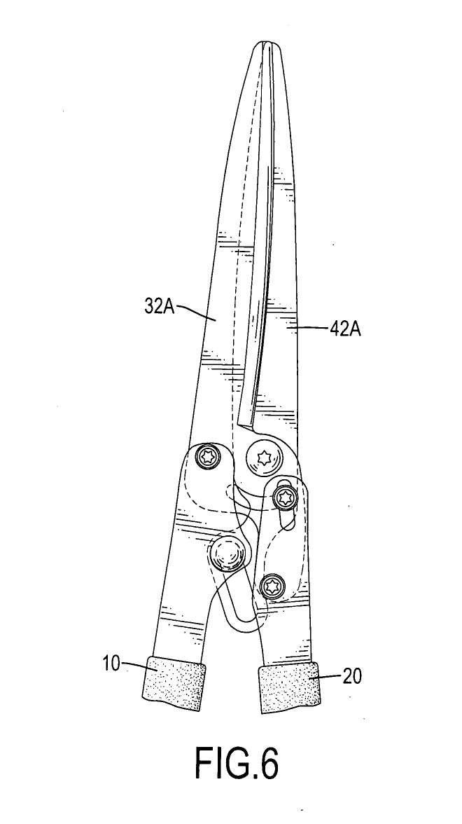

The first blade (30) is pivotally connected to the pivotal end (12) of the first handle (10) with a first pivot (50), is pivotally connected to the second handle (20) with a second pivot (52) and has a cutting end (32,32A), a pivotal end (34) and a curved second slot (36). The cutting end (32,32A) of the first blade (32) may be curved as shown in FIGS. 1 and 2, or straight as shown in FIG. 6. The pivotal end (34) is pivotally connected to the second handle (20) with the second pivot (52). The curved second slot (36) is defined through the first blade (30), corresponds to the first slot (24) and has a first end (362) and a second end (364).

The second blade (40) is pivotally connected to the first blade (30) with a third pivot (54), pivotally connected to the first handle (10) with a fourth pivot (56) and pivotally connected to the pivotal end (22) of the second handle (20) and the first blade (30) with a fifth pivot (58). The second blade (40) has a cutting end (42,42A), a pivotal end (44) and a third slot (46). The cutting end (42,42A) corresponds to the cutting end (32,32A) of the first blade (30) and may be curved as shown in FIGS. 1 and 2, or straight as shown in FIG. 6. The third slot (46) is defined through, preferably through the pivotal end (44) of the second blade (40) and may be straight. The third slot (46) has a first end (462) away from the cutting end (42) of the second blade (40) and a second end (464) facing the cutting end (42). The fourth pivot (56) extends through the first handle (10) and slidably through the third slot (46) to pivotally connect the second blade (42) to the first handle (10) at a first slidable pivoting point. The fifth pivot (58) slidably extends through the first slot (24) and the curved second slot (36) to pivotally connect the second blade (40) to the second handle (20) and the first blade (30) at a second slidable pivoting point. In addition, a sliding collar (48) is slidably held in the third slot (46), and the fourth pivot (56) extends through the sliding collar (48).

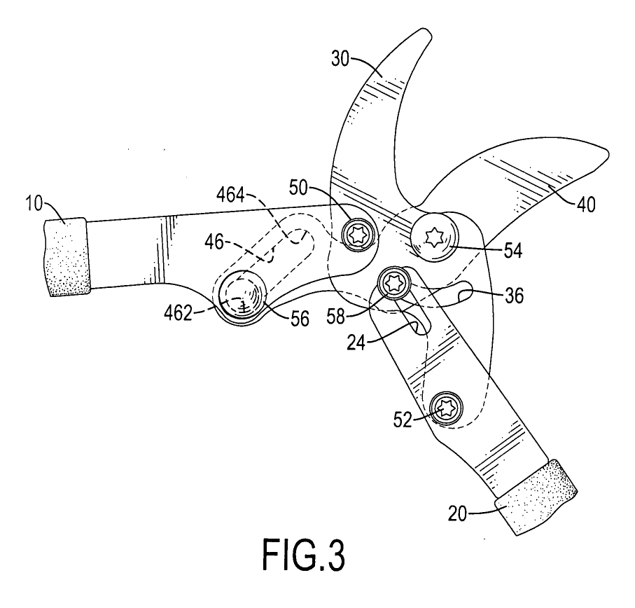

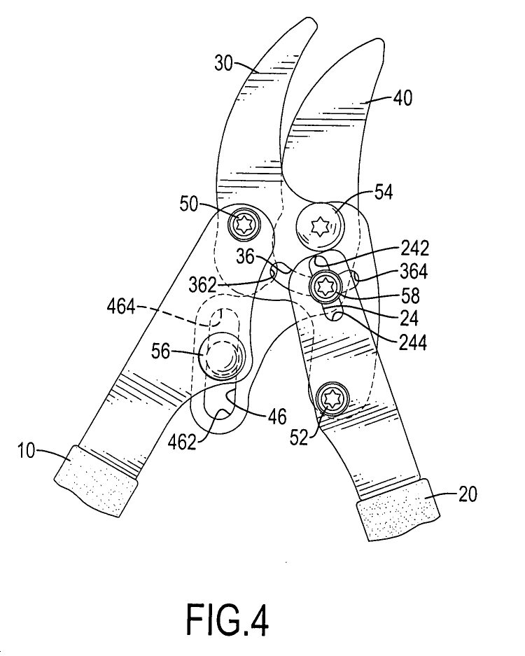

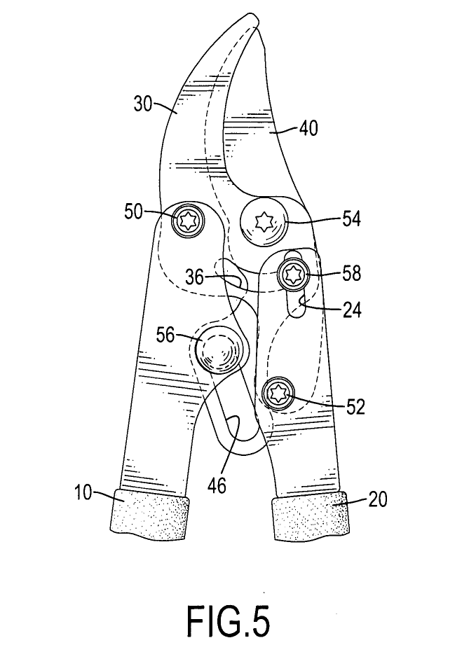

In use, with further reference to FIGS. 3 to 5, the handles (10,20) are firstly separated to open the blades (30,40). At this time, the fourth pivot (56) is located at the first end (462) of the third slot (46), and the fifth pivot (56) is located at the first end (242) of the first slot (24) and the first end (362) of the second slot (36). When the handles (10,20) are squeezed and closed, the blades (30,40) will simultaneously and respectively pivot relative to the handles (10,20) and each other and close to cut or prune an object. When the blades (30,40) are pivoted, the fourth pivot (56) slides along the third slot (46) toward the second end (464) of the third slot (46) and the fifth pivot (58) slides along the first and second slots (24,36) simultaneously toward the second ends (244,364) of the first and second slots (24,36).

During the cutting process, the blades (30,40) are pivoted relative to the handles (10,20) simultaneously and respectively no matter that the user keeps any one of the handles (10,20) stationary. Therefore, the operation of the garden shears in accordance with the present invention for any user is same, to turn over the garden shears for right/left hand user is unnecessary so that the garden shears is easy and convenient in use.

Additionally, with the movements of the pivots (56,58) along the slots (24,36,44), the pivoting points of the blades (30,40) are variable during the cutting process such that the force for cutting or pruning an object is reduced. Consequently, the force for using the shears can be minimized, and the shears can be applied to cut/prune an object with a large diameter and is convenient in use.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A pair of garden shears comprising:
a first handle having a pivotal end;
a second handle having a pivotal end and a first slot defined through the pivotal end of the second handle;
a first blade pivotally connected to the pivotal end of the first handle with a first pivot, pivotally connected to the second handle with a second pivot and having
a cutting end;
a pivotal end pivotally connected to the second handle with the second pivot; and
a curved second slot corresponding to the first slot; and
a second blade pivotally connected to the first blade with a third pivot, pivotally connected to the first handle with a fourth pivot, pivotally connected to the pivotal end of the second handle and the first blade with a fifth pivot and having
a cutting end corresponding to the cutting end of the first blade;
a pivotal end; and
a third slot, wherein
the fourth pivot extends through the first handle and slidably through the third slot to pivotally connect the second blade to the first handle; and
the fifth pivot slidably extends through the first slot and the curved second slot to pivotally connect the second blade to the second handle and the first blade.

2. The garden shears as claimed in claim 1, wherein the third slot is defined through the pivotal end of the second blade.

3. The garden shears as claimed in claim 2 further comprising a sliding collar slidably held in the third slot, wherein
the fourth pivot extends through the sliding collar.

4. The garden shears as claimed in claim 3, wherein the first and third slots are straight.

5. The garden shears as claimed in claim 4, wherein the cutting ends of the first and second blades are curved.

6. The garden shears as claimed in claim 4, wherein the cutting ends of the first and second blades are straight.

7. The garden shears as claimed in claim 1 further comprising a sliding collar slidably held in the third slot, wherein
the fourth pivot extends through the sliding collar.

8. The garden shears as claimed in claim 7, wherein the first and third slots are straight.

9. The garden shears as claimed in claim 1, wherein the first and third slots are straight.
